(19) United States
(12) Patent Application Publication
(10) Pub. No.: US 2009/0315984 A1
(43) Pub. Date: Dec. 24, 2009

(54) VOICE RESPONSIVE CAMERA SYSTEM

(75) Inventors: CHING-FENG LIN, Tu-Cheng (TW); WEN-HWA LIN, Tu-Cheng (TW); I-LIEN LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/248,903

(22) Filed: Oct. 10, 2008

(30) Foreign Application Priority Data
Jun. 19, 2008 (CN) 200810302237.X

(51) Int. Cl. H04N 7/18

(52) U.S. Cl. 348/61

(57) ABSTRACT

A camera system includes a driver rotating a rotor and an attached supporter. Two sound sensors on the supporter measure sound signals from an acoustic source. A camera on the supporter is aligned with the acoustic source when the driver rotates the supporter according to differences between the sound signals.

### TECHNICAL FIELD

The disclosure relates to camera systems and, specifically, to a voice responsive camera system which dynamically tracks an active speaker.

### BACKGROUND

For communication from remote locations, a video conference system is a convenient method. The video conference system provides both video and audio information from participants. Cameras employed in the video conference system are preferably able to frame and track active speakers during the conference. The most common way of doing this is by manual control of the cameras. However, this is inconvenient in practice.

Therefore, it is desired to provide a camera capable of providing automatic tracking of active speakers during a video conference.

### BRIEF DESCRIPTION OF THE DRAWINGS

Many aspects of the camera system can be better understood with reference to the accompanying drawings. The components in the drawings are not necessarily drawn to scale, the emphasis instead being placed upon clearly illustrating the principles of the system. Moreover, in the drawings, like reference numerals designate corresponding parts throughout the several views.

FIG. 1 is an isometric, schematic view of a camera system in accordance with an exemplary embodiment of the disclosure.

FIG. 2 is a functional block diagram of the camera system of FIG. 1.

FIG. 3 is an isometric, schematic view of the camera system in accordance with a second exemplary embodiment of the disclosure.

FIG. 4 is a functional block diagram of the camera system of FIG. 3.

### DETAILED DESCRIPTION

Embodiments of the camera system will now be described in detail with reference to the drawings.

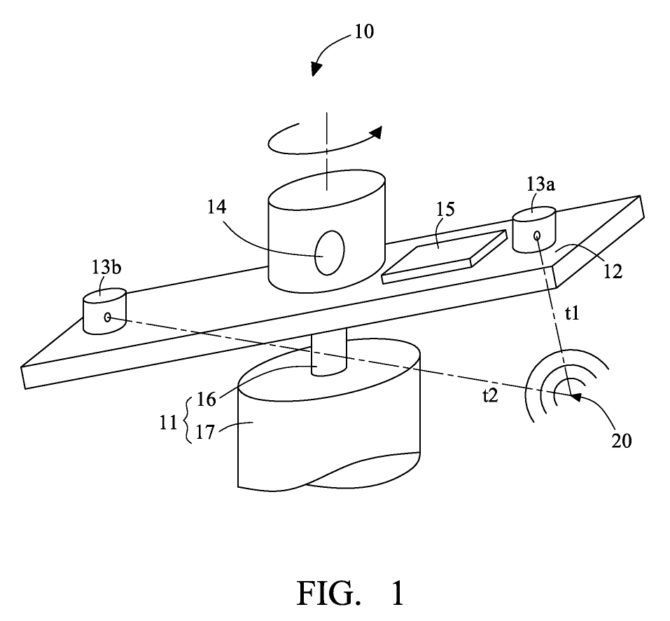

Referring to FIG. 1, an isometric, schematic view of a camera system 10 employed in accordance with an exemplary embodiment of the disclosure is shown. The camera system 10 includes a driver 11, such as a rotary motor having a rotating shaft, a supporter 12, such as a strip-shaped shelf, a first sound sensor 13a, a second sound senor 13b, a camera 14, and a processing unit 15. In this embodiment, the driver 11 includes a rotor 16 and a stator 17. The supporter 12 is attached to the rotor 16. The first sound sensor 13a is configured for measuring a first corresponding sound signal emanating from an acoustic source 20. The second sound sensor 13b is configured for measuring a second corresponding sound signal emanating from the acoustic source 20. The first sound sensor 13a and the second sound sensors 13b are respectively disposed on two distal ends of the supporter 12. The camera 14 is fixed on the supporter 12, located equidistant between 13a, 13b, that is, the middle of the strip-shaped shelf, and is oriented so that the viewing angle thereof includes the perpendicular bisector of the connection line of the two sound sensors, that is, the camera is directed at the bisector of the two sound sensors.

The sound signal measured by the first sound sensors 13a or the second sound sensor 13b can be, for example, a time index representing a time of receipt of a sound wave generated from the acoustic source 20, such as travel time of the sound wave from the acoustic source 20 to the corresponding sound sensor. The sound wave is received and measured by the sound sensor (for example, 13a) to generate the corresponding sound signal. If the acoustic source 20 is substantially located equidistant between the two sound sensors 13a and 13b, the corresponding sound signals measured by the two sound sensors 13a, 13b are substantially the same in the time index. On the contrary, if the acoustic source 20 is located away from the central position, due to inequity between the distances to the two sound sensors 13a and 13b, the sound signals measured by the two sound sensors 13a, 13b corresponding to the same sound wave are different.

The processing unit 15 is configured for calculating a difference between the two time indices measured by the two sound sensors 13a and 13b. The driver 11 drives the supporter 12 to move the camera 14 according to the difference. The camera system 10 then begins measurement of another sound wave generated from the acoustic source 20 and originates new sound signals corresponding thereto. The driver 11 moves the camera 14 according to the difference between the sound signals. In this embodiment, the camera system 10 continues moving the camera 14 until the difference between the time indices measured by the two sound sensors 13a and 13b is zero. Accordingly, the camera 14 is aligned with the acoustic source 20.

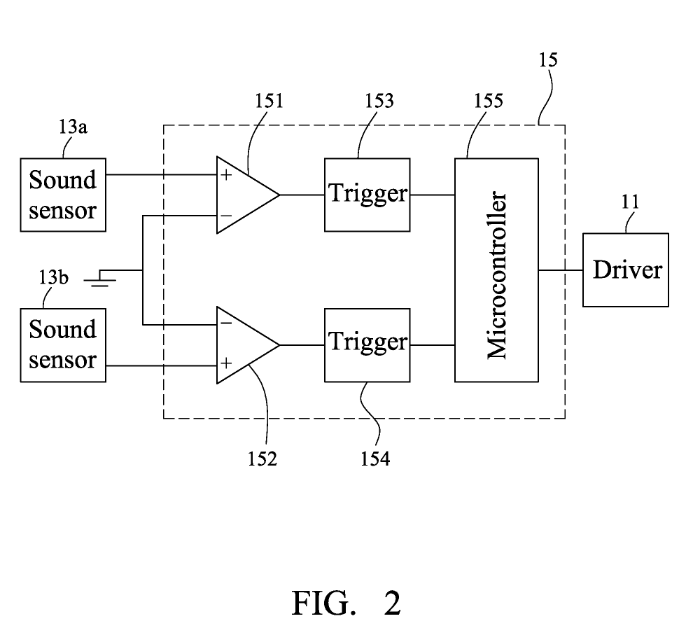

Referring to FIG. 2, a functional block diagram of the camera system 10 of FIG. 1 is shown. The processing unit 15 includes two amplifiers 151, 152, two monostable triggers 153, 154, and a microcontroller 155. The amplifiers 151, 152 are respectively connected to the sound sensors 13a, 13b and are configured for increasing the amplitude of the sound signals. The triggers 153 and 154 respectively connect the two amplifiers 151 and 152 to the microcontroller 155.

The sound signals measured by the sound sensors 13a, 13b in this embodiment are, for example, time indices which represent the time (t₁ or t₂ as shown in FIG. 1) measured by the two sound sensors 13a, 13b receiving the same sound wave. The monostable triggers 153, 154 are respectively connected with the two amplifiers 151, 152. The monostable trigger 153 outputs a first pulse immediately after the first sound sensor 13a measures the first sound signal (t₁). Similarly, the monostable trigger 154 outputs a second pulse immediately after the second sound sensor 13b measures the second sound signal (t₂). The microcontroller 155 controls the driver 11 to move the supporter 12 according to the difference (t₁−t₂) of the sound signals. If the difference (t₁−t₂) is a negative, the supporter 12 is moved to bring the second sound sensor 13b closer to the acoustic source 20. The camera system 10 continues movement of the supporter 12 until the difference (t₁−t₂) is substantially zero. Thereby, the acoustic source 20 is located equidistant between the two sound sensors 13a, 13b and the camera 14 is aligned with the acoustic source 20.

Similarly, if the difference (t₁−t₂) is a positive, the supporter 12 is moved to bring the first sound sensor 13a closer to the acoustic source 20. The camera system 10 continues movement of the supporter 12 until the difference (t₁−t₂) is substantially zero. This facilitates the acoustic source 20 to be located in the central position and thus aligns the camera 14 with the acoustic source 20.

As the distance between the two sound sensors 13a, 13b increases, the difference (t₁−t₂) between the measured first and second sound signals becomes more notable. However, in this embodiment, in consideration of device size, the supporter 12 is 12˜20 centimeters in length.

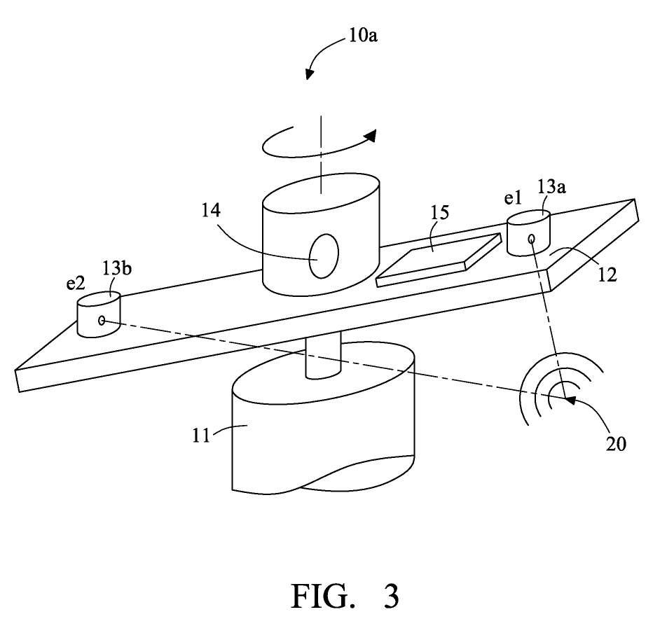

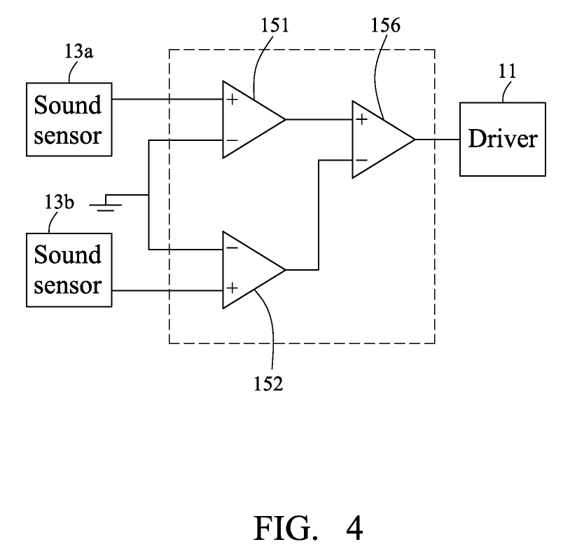

FIG. 3 is an isometric, schematic view of the camera system 10 of a second embodiment. The sound signal measured by the two sound sensors 13a, 13b corresponds to a sound wave of the acoustic source 20. FIG. 4 is a functional block diagram of FIG. 3. The camera system 10 includes a driver 11, a processing unit 15, and two sound sensors 13a, 13b. The sound sensors 13a, 13b in this embodiment are connected to the processing unit 15 and configured for measuring the loudness of the sound signals (e1 and e2) corresponding to a sound wave transmitted from the acoustic source 20. The processing unit 15 includes two amplifiers 151, 152, which are connected to the sound sensors 13a and 13b respectively, and a comparator 156 connected to the two amplifiers 151 and 152. The amplifiers 151 and 152 are configured for increasing the amplitude of the measured sound signals. The comparator 156 compares the amplitudes of the loudness e1, e2. If a difference between the two amplitudes (e₁−e₂) is a negative, the supporter 12 is moved to bring the sound sensor 13b closer to the acoustic source 20 until the difference (e₁−e₂) is substantially zero. Thereby, the camera 14 is aligned with the acoustic source 20.

Similarly, if the difference (e₁−e₂) is a positive, the supporter 12 is moved to bring the sound sensor 13a closer to the acoustic source 20 until the difference (t₁−t₂) is substantially zero. This places the acoustic source 20 in a central position and aligns the camera 14 with the acoustic source 20.

It is to be noted that application of the camera system is not limited to that disclosed, and is equally applicable in any other system requiring tracking function corresponding to sound, such as a security camera system, while remaining well within the scope of the disclosure.

It will be understood that the above particular embodiments are described and shown in the drawings by way of illustration only. The principles and features of the disclosure may be employed in various and numerous embodiments thereof without departing from the scope of the invention as claimed. The above-described embodiments illustrate the scope of the invention but do not restrict the scope of the invention.

What is claimed is:

1. A camera system comprising:
a driver comprising a rotor;
a supporter fixed to the rotor;
a first sound sensor disposed on the supporter and configured for measuring a first corresponding sound signal emanating from an acoustic source;
a second sound sensor, arranged apart from the first sound sensor, disposed on the supporter and configured for measuring a second corresponding sound signal emanating from the acoustic source;
a camera fixed on the supporter; and
a processing unit configured for processing the first and the second sound signals and directing the driver to rotate the supporter, thereby aligning the camera with the acoustic source.

2. The camera system as claimed in claim 1, wherein the supporter comprises a strip-shaped shelf.

3. The camera system as claimed in claim 2, wherein the first and the second sound sensors are respectively disposed on two distal ends of the strip-shaped shelf.

4. The camera system as claimed in claim 1, wherein the camera is located equidistant between the two sound sensors.

5. The camera system as claimed in claim 4, wherein the camera is directed at a bisected direction of the two sound sensors.

6. The camera system as claimed in claim 1, wherein the processing unit is configured for calculating the difference between the first and the second corresponding sound signals.

7. The camera system as claimed in claim 6, wherein the driver is capable of moving the camera according to the difference between the two corresponding sound signals.

8. The camera system as claimed in claim 7, wherein the first and second sound sensors are capable of continually measuring continual sound signals from the acoustic source, and the driver is capable of continually moving the camera until the difference calculated by the processing unit is substantially zero.

9. The camera system as claimed in claim 1, wherein the first and the second corresponding sound signals are travel times of a sound wave from the acoustic source to the sound sensors.

10. The camera system as claimed in claim 1, wherein the processing unit comprises a microcontroller and two amplifiers electrically connected to the two sound sensors respectively, and to the microcontroller.

11. The camera system as claimed in claim 10, wherein the two amplifiers are configured for amplifying the first and the second sound signals.

12. The camera system as claimed in claim 10, wherein the processing unit comprises two monostable triggers electrically which connect the two amplifiers respectively to the microcontroller.

13. The camera system as claimed in claim 12, wherein each of the monostable triggers is configured for outputting a pulse immediately after the corresponding sound sensor measures the sound signal.

14. The camera system as claimed in claim 9, wherein the processing unit comprises a comparator configured for comparing the amplitude of the sound signals.

15. The camera system as claimed in claim 2, wherein the length of the shelf is between 12 and 20 centimeters.

16. A camera system comprising:
a driver comprising a rotor;
a supporter fixed to the rotor;
a first sound sensor disposed on the supporter and configured for measuring a first corresponding sound signal emanating from an acoustic source;
a second sound sensor, arranged apart from the first sound sensor, disposed on the supporter and configured for measuring a second corresponding sound signal emanating from the acoustic source;
a camera fixed to the supporter and directed at a perpendicular bisector of a connection line of the two sound sensors; and
a processing unit configured for processing the two measured sound signals to obtain a difference therebetween and directing the driver to rotate the supporter based upon the obtained difference to aim the camera at the sound source.

17. The camera system as claimed in claim 16, wherein the first and the second sound sensors are respectively disposed on two distal ends of the supporter.

18. The camera system as claimed in claim 16, wherein the processing unit comprises:
two amplifiers respectively coupled to the two sound sensors and configured for amplifying the sound signals;
two monostable triggers respectively coupled to the two sound sensors and configured for outputting pulses when the two sound signals are measured; and
a microcontroller configured for obtaining a difference between the two output pulses and continuously directing the driver to rotate the supporter based upon the difference until the difference is decreased to substantially zero.
